(19) United States
(12) Patent Application Publication
(10) Pub. No.: US 2019/0140732 A1
(43) Pub. Date: May 9, 2019

(54) Wireless Access Bridge

(71) Applicant: Nokia of America Corporation, Murray Hill, NJ (US)

(72) Inventors: Shahriar Shahramian, Murray Hill, NJ (US); Yves Baeyens, Murray Hill, NJ (US)

(73) Assignee: Nokia of America Corporation, Murray Hill, NJ (US)

(21) Appl. No.: 16/095,990

(22) PCT Filed: Apr. 26, 2017
(86) PCT No.: PCT/US2017/029555

§ 371 Date: Oct. 24, 2018

Related U.S. Application Data
(60) Provisional application No. 62/327,860, filed on Apr. 26, 2016.

(51) Int. Cl. H04B 7/155; H04B 5/02; H04B 5/00; H04W 72/04; H04W 88/16

(52) U.S. Cl. CPC H04B 7/15507; H04B 5/02; H04W 88/16; H04B 5/0037; H04W 72/0453; H04B 5/0031

(57) ABSTRACT

Embodiments provide an apparatus, e.g. a wireless data access bridge, that includes two antennas. A first antenna is configured to communicate with a wireless data access point via a first signal at a first radio-frequency (RF) carrier frequency. A second antenna is configured to communicate with a wireless gateway device via a second signal at a second lower RF signal carrier frequency. An interface circuit is configured to recover data from the first signal and to modulate the second signal using the recovered data. In some embodiments the apparatus may operate as a bridge between a microwave-frequency network access point and a residential gateway device in the presence of an attenuating barrier, e.g. a treated window surface.

### TECHNICAL FIELD

The present disclosure relates generally to the field of radio-frequency communications, and, more particularly, but not exclusively, to methods and apparatus useful for converting a wireless computer network signal to provide data propagation through obstacles.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Connection to a computer network, e.g. the Internet, may conventionally rely in part on a wired connection (e.g. cable), optical connection, or wireless connection through a mobile telephone network. Such connections each have an associated cost model associated therewith, which may make one connection type more suitable than other connection types in a particular application. Factors such as geography, existing infrastructure, and socio-economic status of a particular area may effect of the economics of service provision to any particular area.

### SUMMARY

The inventors disclose various apparatus and methods that may be beneficial applied to providing wireless network connectivity to a structure, e.g. having RF-attenuating windows. While such embodiments may be expected to provide improvements in performance and/or reduction of cost of relative to conventional approaches, no particular result is a requirement of the present invention unless explicitly recited in a particular claim.

One embodiment provides an apparatus, e.g. a wireless data access bridge. The apparatus includes two antennas. A first antenna is configured to communicate with a wireless data access point via a first signal at a first radio-frequency (RT) carrier frequency. A second antenna is configured to communicate with a wireless gateway device via a second signal at a second lower RF signal carrier frequency. An interface circuit is configured to recover data from the first signal and to modulate the second signal using the recovered data.

In various embodiments the first antenna is located within an outdoor unit, and the second antenna is located within an indoor unit. In such cases, the apparatus further comprises an intermediate transceiver pair configured to communicate between the first and second units. Such embodiments may also include a plurality of magnetic couplers to couple the indoor and outdoor units on either side of a barrier, e.g. a window. The magnetic couplers may be oriented to enforce a preferred alignment of the indoor unit to the outdoor unit. Some embodiments of the apparatus include an inductive power receiver configured to remotely receive operating power.

In some embodiments the first antenna is configured to communicate with the wireless art access point via a first communication protocol, and the second antenna is configured to communicate with the wireless gateway device via a second different communication protocol. In some embodiments the first antenna includes a phased-array antenna. In some embodiments the first antenna is configured to communicate with the data access point at a microwave frequency. In some embodiments the second antenna is configured to communicate with the wireless gateway device using the IEEE 802.11 standard.

In some embodiments the first carrier frequency is at least twice the second carrier frequency. In some embodiments the first carrier frequency is no less than about 10 GHz, and the second carrier frequency is no greater than about 5 GHz.

Another embodiment, e.g. an apparatus, includes an antenna and an optical transceiver. The antenna is configured to communicate with a wireless data access point via a first signal at a microwave carrier frequency. The optical transceiver is configured to communicate with an optical interface device via an optical carrier signal. An interface circuit is configured to recover data from the first signal and to modulate said optical carrier signal using said recovered data.

Other embodiments include a method that includes directing to a subscriber any of the apparatus as described above for self-service installation.

Other embodiments provide methods of manufacturing an apparatus, e.g. according to any of the embodiments described above.

### BRIEF DESCRIPTION OF THE DRAWINGS

A more complete understanding of the present invention(s) may be obtained by reference to the following detailed description when taken in conjunction with the accompanying drawings wherein:

FIGS. 1A and 1B respectively illustrate top and bottom views of a first apparatus, e.g. an outdoor unit, configured according to various embodiments, e.g. a transponder, including two antennas and an inductive power receiver;

FIG. 2 illustrates a second apparatus, e.g. an indoor unit, according to various embodiments, that includes an inductive power transmitter configured to couple to the inductive power receiver of FIG. 1B; and

FIGS. 3A and 3B illustrate communication by the apparatus of FIGS. 1A and 1B with a first RF link at a first frequency to an provider access point, and a second RF link at a second different frequency to a subscriber gateway device, wherein the apparatus of FIGS. 1A and 1B is coupled to the apparatus of FIG. 2 through a glass sheet, with FIG. 3A representing transmission to the gateway by the outdoor unit of FIGS. 1A/1B, and FIG. 3B representing transmission to the gateway by the indoor unit of FIG. 2.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

Microwave relays have been used for point-to-point communication since at least the 1950s. One advantage of conveying data via microwave signals is that such signals inherently have a greater bandwidth than lower-frequency RF signals. However, such signals are typically limited to line-of-sight communication, and may be attenuated by various effects, e.g. rain. While the greater bandwidth makes microwave transmission an attractive option for distribution of internet connectivity, the attenuation potential poses technical challenges. More specifically, in the context of residential and commercial buildings, attenuation of microwave signals through windows may be difficult or impractical, especially in the case of so-called high-E glass. Such glass is typically produced by depositing a transparent metal layer on the glass surface such that short (e.g. visible) wavelengths may pass through with little attenuation, while long (e.g. infrared) wavelengths are reflected. In many cases, such a layer will also be an effective barrier to microwave propagation.

In one distribution model, a microwave transceiver may be located to provide service to one or more subscribers for which there is a clear path between the subscriber structure (e.g. home or office), but for which the ability to penetrate the structure by the microwave signal is unreliable or unknown. Thus, a need exists for a solution that allows the advantages of a microwave carrier to be realized, e.g. high data bandwidth, but also provides a reliable data path to the interior of the structure.

Embodiments of apparatus and methods are described herein that may overcome some of the obstacles to practical use of microwave signal carriers to provide data to and receive data from a structure. Some such embodiments are expected to provide particular advantage for reducing costs of such apparatus and methods compared to conventional solutions, such as a microwave dish antenna located at each structure served.

To address deficiencies of such conventional implementations, various embodiments described herein provide a two-part device. The two parts may be collectively considered as an apparatus, and either of the two parts may be considered an apparatus. A first apparatus, sometimes referred to without limitation as an “outdoor unit”, in some embodiments includes two antennas and an inductive power receiver. A second apparatus, sometimes referred to without limitation as an “indoor device”, in some embodiments includes an inductive power transmitter. The indoor unit may be used to inductively power the outdoor unit through a dielectric barrier, e.g. a window pane, allowing the outdoor unit to operate on the exterior of a residential structure without access to a corded power supply. The outdoor unit may receive data from and transmit data to a data access point such as a pole-mounted wireless transceiver that provides connectivity to a service-provider network and/or the Internet. In some embodiments the outdoor unit may receive data from and transmit data to a local gateway device inside the structure, e.g. a wireless local area network (LAN) device. In other embodiments the outdoor unit may include a short-range transceiver that communicates with a complementary transceiver located within the indoor unit to transfer data, and the indoor unit may communicate with the gateway device. In either case, the outdoor unit provides a bridge between the service-provider network, and/or the Internet, to the local gateway device.

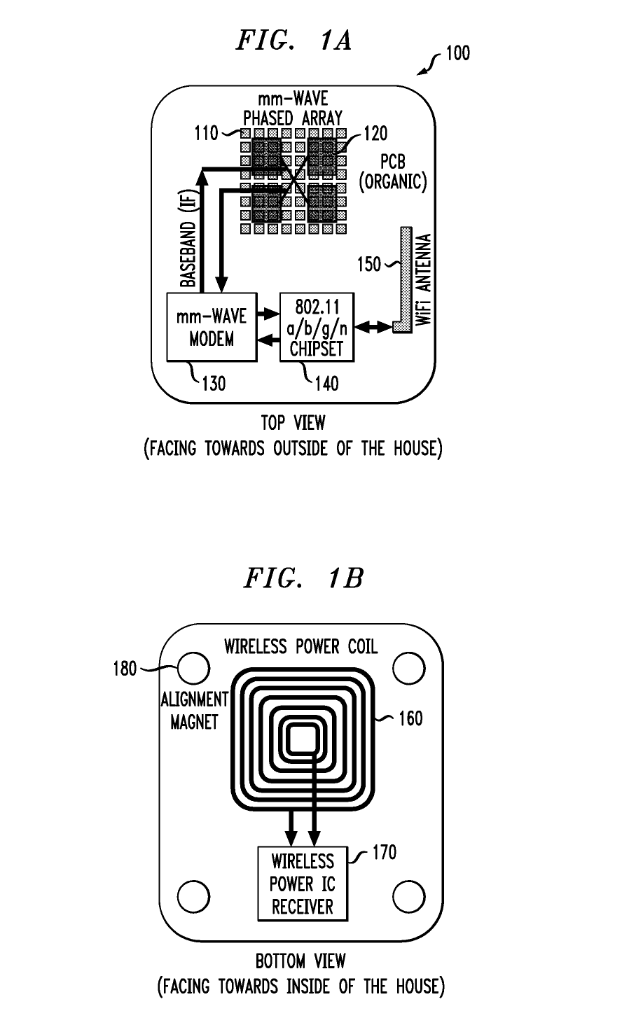

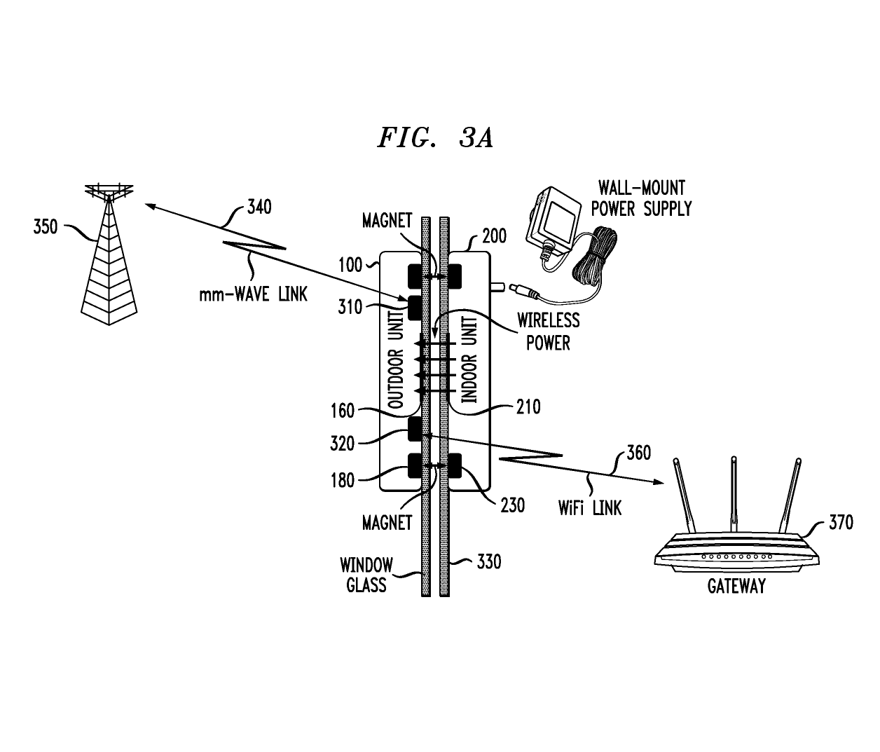

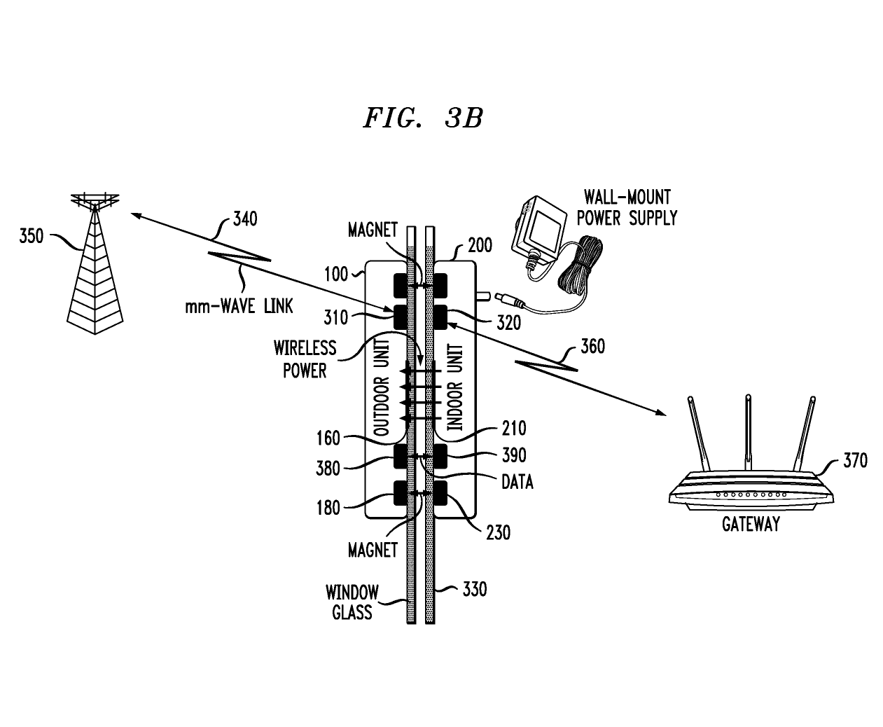

Turning to FIGS. 1A and 1B, displayed is an embodiment of an apparatus 100, e.g. an outdoor unit, that may operate as an RF bridge to a wireless data access point. (For example, refer to access point 350 in FIG. 3.) FIG. 1A shows a front view, while FIG. 1B shows a rear view. It will be appreciated that the designations “front” and “rear” are arbitrary and are used for reference in this discussion without limitation. The front view includes a first antenna 110, circuits 120, a modem 130, a wireless network interface 140, and a second antenna 150. The rear view includes an inductive coil 160, control electronics 170 and mounting positioning elements 180. Preferably the apparatus 100 includes a weather-resistant housing for protection from the elements. For the purpose of discussion, without implied limitation, the antenna 110, circuits 120 and modem 130 may be referred to collectively as the “primary transceiver”, while the wireless network interface 140 and antenna 150 may be referred to collectively as the “secondary transceiver”.

The antenna 110 may be of any type suitable for communication with the wireless access point. It is shown illustratively as a phased-array antenna without limitation thereto, which may be especially suited to some applications, such as for alignment with the wireless access point when the access point is not located directly facing the outdoor unit 100. The circuits 120 may cooperate with the antenna 110 to transmit data to and receive data from the wireless access point.

The access point and primary transceiver will typically operate at an RF frequency greater than that of the secondary transceiver and the local gateway device. While embodiments are not limited to any particular frequency of operation, unless otherwise expressly stated, it is expected that the embodiments described herein may find particular utility in situations in which the access point transmits at a frequency that is significantly attenuated by the exterior of a structure to which the outdoor unit 100 is attached. Such frequencies may be those sometimes included in the “microwave” portion of the electromagnetic (EM) spectrum, which may include frequencies between about 300 MHz and about 300 GHz. In some embodiments the access point and primary transceiver transmit and receive using RF signals having a frequency of at least about 7 GHz, and the antenna 110 is correspondingly configured to operate in this frequency range. Such frequencies may lie within portions of ITU bands 10 and 11. In some embodiments the antenna 110 is configured to operate in the mm (millimeter) band, which for the purposes of this discussion is defined as including wavelengths as long as 10 mm (1 cm), corresponding to a frequency of about 30 GHz. In various embodiments the antenna 110, circuits 120 and modem 130 are configured to operate at a first frequency higher than a second frequency at which the network interface 140 and antenna 150 are configured to operate. In some embodiments the first frequency is at least about 7 GHz and the second frequency is no greater than about 5 GHz. In some embodiments the first frequency is at least about two times the first frequency, e.g. at least 10 GHz fir the first frequency and no greater than about 5 GHz for the second frequency. Such embodiments may advantageously limit cross-coupling between the antenna 110 and the antenna 150.

The network interface 140 may be configured to operate in a manner compliant with a communication protocol suitable for communication with a subscriber gateway device, illustrated without implied limitation as the IEEE 802.11 standard protocol in any of its revision levels, e.g. 802.11 a/b/g/n. The antenna 150 is configured to operate at any frequency at which the network interface 140 is configured to operate. Those skilled in the pertinent art will appreciate that the 802.11 standard includes several operating protocols. The “n” protocol, which many consumer-level wireless LANs are configured to support, may transmit at 2.5 GHz (ITU band 9) and/or 5 GHz (ITU band 10). However, some protocols, e.g. the “ad” protocol, may transmit at 60 GHz. While embodiments of the apparatus 100 are not limited to supporting any particular protocol, some embodiments provide advantageous utility in the context of residential applications. This aspect is described in greater detail below.

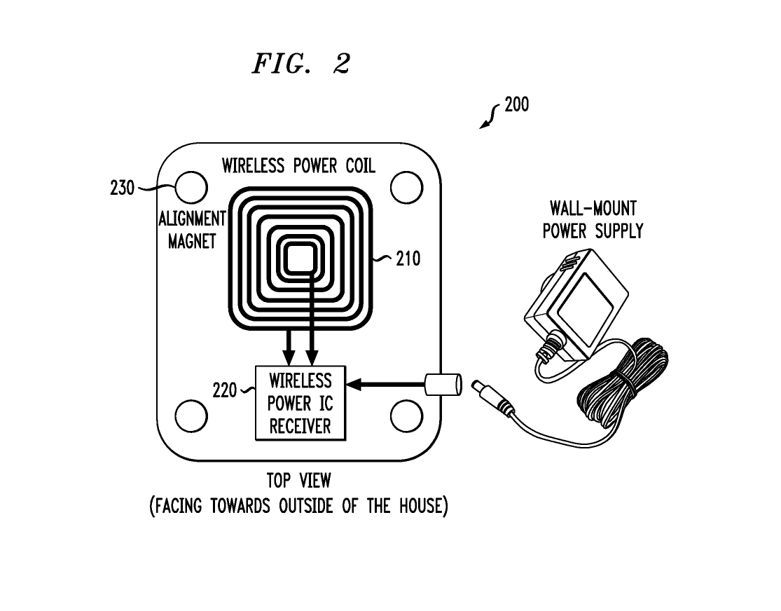

Referring to FIG. 1B, the apparatus 100 includes the coil 160 and the control electronics 170. The coil 160 is configured to receive power wirelessly from a suitable transmitter, e.g. the apparatus 200 described below and in FIG. 2. The control electronics 170 receive unconditioned power from the coil 160 and converts the power to any suitable form needed to operate the model 130 and network interface 140. Those skilled in the art are familiar with such devices, which are thus not described further here. The positioning elements 180 may be or include one or both of a magnetically polarized material, e.g. a ferromagnet, or a ferromagnetic material suitable for coupling to a ferromagnet. Preferably, such a ferromagnet is a rare-earth magnet, some of which have an advantageously high remanence (Bᵣ), or colloquially, has a high magnetization. While shown located at the corners of the apparatus 100, the positioning elements may be located in any location desired to couple to the apparatus 200. This aspect is described further below.

Referring now to FIG. 2, an embodiment of the apparatus 200, e.g. an indoor unit, is illustrated. The apparatus 200 includes an inductive coil 210 and control electronics 220. The control electronics 220 receive power from a wired source, e.g. an unreferenced residential AC (alternating current) power adapter. The control electronics 220 condition the power for transmission via the coil 210 to the coil 160 of the outdoor unit 100. Positioning elements 230 correspond in location to the positioning elements 180 of the outdoor unit 100. These elements 230 may also be or include one or both of a magnetically polarized material, e.g. a ferromagnet, or a ferromagnetic material suitable for coupling to a ferromagnet. In general, each coupling element 230 is configured to magnetically couple to a corresponding one of the coupling elements 180. Referring to a corresponding pair of one of the coupling elements 180 and one of the coupling elements 230, both elements of the pair may be magnets, or only one may be a magnet with the other being an unmagnetized ferromagnetic material, e.g. an iron alloy. In cases in which the corresponding element pair includes two magnets, the magnets are oriented such that the magnetic pole presented by the indoor unit 200 complements the magnetic pole presented by the outdoor unit 100, e.g. N (north) to S (south) or vice versa.

Referring to the pattern of elements 180 and 230, the orientation of the magnetic poles may be configured to encourage or enforce a particular orientation of the indoor unit 200 to the outdoor unit 100. Using the illustrated nonlimiting example of a square pattern, three of the corresponding pairs of elements 180/230 may be oriented in one direction, e.g. such that the N-S magnetic vector points to the outside unit 100, while the remaining corresponding pair of elements 180/230 may be oriented in the other direction, e.g. such that the N-S magnetic vector points to the inside unit 200. Thus, when the inside unit 200 is aligned with the outside unit 100, a proper orientation will be apparent. Thus, for example, a preferred alignment of the coils 160 to the coils 210 may be enforced.

Referring to FIGS. 1 and 2 concurrently, in some embodiments the secondary transceiver (including the wireless network interface 140 and antenna 150) may be located in the indoor unit 200 rather than the outdoor unit 100. In such embodiments each of the indoor unit 100 and outdoor unit 200 may include a suitable interface such that data may be transferred between the two units. Such interfaces may include, e.g. an RF interface using a carrier frequency different from both the primary and secondary transceivers, an optical interface, or an ultrasound acoustic interface. Such options would each require a transmitter/receiver pair located at each of the outdoor unit 100 and the indoor unit 200 as appropriate to the type of signal carrier used, e.g. RF, optical or acoustic.

Now referring to FIG. 3A, an example is shown of use of the outdoor unit 100 and indoor unit 200 for embodiments in which the outdoor unit 100 includes both the primary and secondary transceivers, respectively shown schematically as 310 and 320. In this example, the units 100/200 are coupled via the coupling elements 180/230 via a glass sheet 330, e.g. a window pane. Power is inductively coupled from the indoor unit 200 to the outdoor unit 100 as previously described. The outdoor unit 100 communicates bidirectionally via a link 340 with a wireless data access point 350, and via a link 360 with a subscriber gateway device 370 as previously described.

As used herein, an access point is a node of a provider of network service, such as an internet service provider (ISP), and is generally capable of providing service to multiple subscribers to the network service. An access point may provide connectivity by any suitable communication protocol standard. Without implied limitation, the access point 350 may support TDMA (time-division multiple access), CDMA (code-division multiple access) TDMA (frequency-division multiple access), IEEE 802.16 (sometimes referred to as WiMAX), ITU 4G, LTE and/or the 5G standard under current development.

Illustratively the gateway device 370 is a wireless router, which may provide connectivity via any suitable communication protocol standard. Without implied limitation, the gateway device is configured to support the IEEE 802. 11 standard in any of its existing or future-developed forms, e.g. 802.11a/b/g/n/ad/ax WLAN (wireless LAN) standards.

The outdoor unit 100 receives the signal from the access point 350, recovers data from the received signal, and modulates a second signal using the received data to communicate with the gateway device 370. The process is bidirectional, such that the outdoor unit 100 may also receive a transmitted signal from the gateway device 370, recover data from the signal and retransmit a signal to the access point 350 using the received data.

As described previously, the link 340 may employ a carrier hat has a frequency that is typically greater than the frequency of a carrier wave of the link 360. In the illustrated nonlimiting example, the link 340 is a mm-wave link, e.g. falling within the range of 30 GHZ-300 GHz. Also in this illustrated nonlimiting example, the link 360 is a Wifi link, e.g. having a frequency of about 2.5 GHz and/or about 5 GHz.

FIG. 3B illustrates a second embodiment described previously, in which the secondary transceiver 320 is located within the indoor unit 200. An intermediate transceiver 380 located within the outdoor unit 100 communicates through the glass sheet 330 with another intermediate transceiver 390 within the indoor unit. The secondary transceiver 200 communicates with the gateway device 370 as previously described, but the link 360 is wholly contained within the interior of the structure served by the gateway device 370. In an embodiment, the link 360 may be an optical link, in which case the gateway device 370 may be include or be replaced by any suitable optical transceiver. Such embodiments may be useful, e.g. in industrial facilities that already include an optical data transceiving system for other purposes, such as computing device and/or industrial equipment interconnectivity.

In some cases the glass sheet 330 includes so-called “E” glass. Low-E, or low-emissivity, glass may include various coatings that reduce the transmission of infrared light therethrough to reduce the heat load on the structure of which the glass (window) is a part. Such coatings may also significantly attenuate an RF signal having a frequency at which the access point 350 operates. Thus it may be difficult in the general case, and in some cases impossible, to provide a direct link from the gateway device 370 to the access point 350 when low-E glass is used. The access point 350 may be located on a utility pole or antenna tower, and thus any signal attenuation due to the glass sheet 330 adds to attenuation due to distance. The relatively low power provided by typical, e.g. consumer-grade, wireless routers is insufficient in general to directly communicate reliably with a centralized service-provider transceiver.

However, the outdoor unit 100, by virtue of the antenna 110, is configured to effectively communicate directly with such a centralized service-provider transceiver. By recovering data from the access point 350 via the link 340 and communicating via the separate link 360 with the gateway device 370 (from either the outdoor unit 100 or the indoor unit 200), the outdoor unit 100 can communicate with the access point 350 at a frequency that is not significantly attenuated by the glass sheet 330, thus acting as a bridge between the access point 350 and the gateway device 370.

Moreover, the units 100 and 200 may be well-suited to installation by a consumer-resident. A service provider may send to a subscriber the units 100/200 for self-service installation. The magnetic mounts provide simple, tool-free installation, and may be configured to ensure proper orientation of the two units, as previously described. Thus an internet service provider (ISP) may ship the units 100 and 200 to the consumer-resident with simple instructions for self-installation. Of course, the described embodiments are not limited to residential use, or self-installation.

The apparatus 100 may optionally include a battery (not shown) to power the outdoor unit 100 for a sufficient period of time to operate without receiving power from the apparatus indoor unit 200. Thus, the outdoor unit 100 may operate for a short period of time in the event of a loss of line power to the indoor unit 200. The battery may also allow the outdoor unit 100 to be operated while an installer seeks a sufficiently strong signal from the access point 350. The indoor unit 200 may also include a battery to operate for short periods in the absence of line power. In this manner, the indoor unit 200 may continue to provide power during limited interruptions of AC power service.

Furthermore, in some embodiments the indoor unit 100 may include a visual indicator of signal strength, e.g. a green LED that illuminates when the signal strength is adequate, or several LEDs, a number which illuminate proportionate to the signal strength. Optionally, the information visually conveyed by the LED or LEDs may be provided aurally, e.g. by a tone that changes pitch depending on signal strength. Such an aural signal may be provided in addition to or in lieu of a visual signal.

Although multiple embodiments of the present invention(s) have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. An apparatus, comprising:
a first antenna configured to communicate with a wireless data access point via a first signal at a first radio-frequency (RF) carrier frequency;
a second antenna configured to communicate with a wireless gateway device via a second signal at a second lower RF signal carrier frequency; and
an interface circuit configured to recover data from the first signal and to modulate said second signal using said recovered data.

2. The apparatus of claim 1, wherein said first antenna is located within an outdoor unit and said second antenna is located within an indoor unit, and further comprising an intermediate transceiver pair configured to communicate between said first and second units.

3. The apparatus of claim 2, wherein said indoor unit and/or said outdoor unit includes a plurality of magnetic couplers oriented to enforce a preferred alignment of said indoor unit to said outdoor unit.

4. The apparatus of claim 1, wherein said second antenna is configured to communicate with said wireless gateway device using the IEEE 802.11 standard.

5. The apparatus of claim 1, wherein said first antenna includes a phased-array antenna.

6. The apparatus of claim 1, wherein said first antenna is configured to communicate with said data access point at a microwave frequency.

7. The apparatus of claim 1, further comprising an inductive power receiver configured to remotely receive operating power.

8. The apparatus of claim 1, wherein said first carrier frequency is no less than about 10 GHz, and said second carrier frequency is no greater than about 5 GHz.

9. The apparatus of claim 1, wherein said first carrier frequency is at least twice said second carrier frequency.

10. The apparatus of claim 1, wherein said first antenna is configured to communicate with said wireless data access point via a first communication protocol, and said second antenna is configured to communicate with said wireless gateway device via a second different communication protocol.

11. A method, comprising directing to a subscriber the apparatus of claim 1 for self-service installation.

17. A method, comprising:
configuring a first antenna to communicate with a wireless data access point via a first signal at a first radio-frequency (RF) carrier frequency;
configuring a second antenna to communicate with a wireless gateway device via a second signal at a second lower RF signal carrier frequency; and
configuring an interface circuit to recover data from the first signal and to modulate said second signal using said recovered data.

13. The method of claim 12, wherein said first antenna is located within an outdoor unit and said second antenna is located within an indoor unit, and further comprising configuring an intermediate transceiver pair to communicate between said first and second units.

14. The method of claim 13, wherein said indoor unit and/or said outdoor unit includes a plurality of magnetic couplers oriented to enforce a preferred alignment of said indoor unit to said outdoor unit.

15. The method of claim 12, wherein said second antenna is configured to communicate with said wireless gateway device using the IEEE 802.11 standard.

16. The method of claim 12, wherein said first antenna includes a phased-array antenna.

17. The method of claim 12, wherein said first antenna is configured to communicate with said data access point at a microwave frequency.

18. The method of claim 12, further comprising configuring an inductive power receiver to remotely receive operating power.

19. The method of claim 12, wherein said first carrier frequency is at least twice said second carrier frequency.

20. The method of claim 12, further comprising configuring said first antenna to communicate with said wireless data access point via a first communication protocol, and configuring said second antenna to communicate with said wireless gateway device via a second different communication protocol.

21. An apparatus, comprising:
an antenna configured to communicate with a wireless data access point via a first signal at a microwave carrier frequency;
an optical transceiver configured to communicate with an optical interface device via an optical carrier signal; and
an interface circuit configured to recover data from the first signal and to modulate said optical carrier signal using said recovered data.
